(19) United States
(12) Patent Application Publication
(10) Pub. No.: US 2025/0141000 A1
(43) Pub. Date: May 1, 2025

(54) METAL-RESIN JOINT AND METHOD OF MANUFACTURING METAL-RESIN JOINT

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yozo UCHIDA, Toyota-shi (JP); Yuki SATO, Toyota-shi (JP); Satoshi FUJIMURA, Toki-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/887,038

(22) Filed: Sep. 17, 2024

(30) Foreign Application Priority Data
Oct. 18, 2023 (JP) 2023-179717

(51) Int. Cl. H01M 50/188; B29C 45/14; B29K 705/00; B29L 31/34; B32B 3/26; B32B 3/30; B32B 15/08; H01M 50/193; H01M 50/197

(52) U.S. Cl. CPC H01M 50/188; B29C 45/14311; B32B 3/266; B32B 3/30; B32B 15/08; H01M 50/193; H01M 50/197; B29C 2045/14868; B29K 2705/00; B29L 2031/3468

(57) ABSTRACT

A metal-resin joint includes a metal member having a continuous band-shaped resin joined portion on a metal surface, and a resin member joined and fixed to the resin joined portion over the entire periphery in a circumferential direction. The resin joined portion has a continuous band-shaped recess arranged portion in which numerous bowl-shaped recesses are arranged while partially overlapping, and the recess arranged portion includes a continuous band-shaped nano-roughened portion on which high nanocolumns stand numerously, and a non-nano-roughened portion. The resin member is joined to the nano-roughened portion over the entire periphery with a resin material filling gaps between the high nanocolumns standing numerously on the nano-roughened portion.

### CROSS-REFERENCE TO RELATED APPLICATIONS

This application is based upon and claims the benefit of priority from the prior Japanese Patent Application No. 2023-179717 filed on Oct. 18, 2023, the entire contents of which are incorporated herein by reference.

### BACKGROUND

### Technical Field

The disclosure relates to a metal-resin joint in which a resin member is joined and fixed to a metal member, and also relates to a method of manufacturing the metal-resin joint.

### Related Art

As one example of the metal-resin joint in which the resin member is joined and fixed to the metal member, a metal-resin joint including a metal member having a resin joined portion of a continuous band shape (e.g., an annular or frame-like shape) on a metal surface and a resin member joined to the resin joined portion over the entire periphery in its circumferential direction and fixed to the metal member is known. The metal-resin joint of this type is included in a power storage device, such as a battery. Specifically, a battery is known in which positive and negative terminal members are fixed via respective resin members to a case lid member in the form of a rectangular plate that constitutes a case in the form of a rectangular parallelepiped box. Each of the terminal members is inserted through a through hole formed in the case lid member, to extend from the inside of the case to the outside, and the resin member is hermetically joined to the case lid member and the terminal member while insulating these members from each other, to fix the terminal member to the case lid member. In the battery of this type, the terminal member (metal member) and the resin member joined and fixed to the terminal member correspond to the “metal-resin joint” mentioned above. The case lid member (metal member) and the resin member joined and fixed to the case lid member also correspond to the “metal-resin joint”. The battery described above is disclosed in, for example, Japanese unexamined patent application publication No. 2022-079172 (JP 2022-079172 A).

### SUMMARY

### Technical Problems

As one example of a method of surface roughening the resin joined portion of the metal member, a pulsed laser beam is intermittently applied to the resin joined portion of the metal member while shifting the irradiation position to roughen the resin joined portion at the nano-level (nano-order). More specifically, the resin joined portion is irradiated with the pulsed laser beam so that numerous bowl-shaped recesses that are dented in the shape of bowls are formed in the resin joined portion, to form a recess arranged portion, and nano-level nanocolumns formed by joining particles derived from metal that forms the metal member together into strings of beads, into the form of columns, stand together in large numbers on the surfaces of the bowl-shaped recesses. It may be considered that, by forming the recess arranged portion on the resin joined portion of the metal member in this manner, the metal member and the resin member can be joined firmly with high airtightness.

However, the inventor has found, through investigation, that even when the recess arranged portion is formed on the resin joined portion as described above, the above-mentioned nanocolumns may not be formed or nanocolumns of suitable size (height) may not be formed on the surfaces of the bowl-shaped recesses, depending on the order and position of pulsed laser irradiation (the order of formation and arrangement of the bowl-shaped recesses), etc. That is, it has been found that a non-nano-roughened portion with no nanocolumns or low nanocolumns is present in the recess arranged portion, in addition to a nano-roughened portion in which nanocolumns of suitable height stand together in large numbers. More specifically, when the recess arranged portion is formed by passing the pulsed laser beam over to form a plurality of rows of consecutive recess areas in each of which a plurality of bowl-shaped recesses is arranged in a row, the consecutive recess area formed last, in particular, becomes the non-nano-roughened portion with no nanocolumns or low nanocolumns.

Furthermore, it has been found that in the non-nano-roughened portion, the resin member cannot be joined firmly with high airtightness to the resin member; therefore, the seal between the metal member and the resin member is not sufficient, depending on the arrangement pattern of the non-nano-roughened portion. For example, in the battery described above, moisture outside the battery may pass through between the terminal member and the resin member or between the case lid member and the resin member and enter the battery, or conversely, the electrolyte contained in the battery may pass through between the terminal member and the resin member or between the case lid member and the resin member and leak outside the battery.

The disclosure was made in view of the situation as described above, and provides a metal-resin joint in which a resin member is joined and fixed to a metal member with good seal performance between the metal member and the resin member. The disclosure also provides a method of manufacturing the metal-resin joint.

### Means of Solving the Problems

(1) One aspect of the disclosure for solving the above problem is a metal-resin joint including a metal member having a continuous band-shaped resin joined portion on a metal surface, and a resin member joined to the resin joined portion over the entire periphery in a circumferential direction of the resin joined portion to be fixed to the metal member. In the metal-resin joint, the resin joined portion of the metal member has a recess arranged portion in which numerous bowl-shaped recesses each having a diameter of 30 μm to 300 μm and dented in the form of a bowl are arranged while partially overlapping, and the recess arranged portion has a continuous band shape extending over the entire periphery in the circumferential direction. The recess arranged portion includes a nano-roughened portion having a continuous band shape extending over the entire periphery in the circumferential direction, and the nano-roughed portion has nanocolumns formed by joining particles derived from a metal that forms the metal member and having a diameter of 100 nm or less together like strings of beads, into the form of columns, the nanocolumns comprising high nanocolumns standing numerously on the nano-roughened portion and having a height of 40 nm or greater. The recess arranged portion includes a non-nano-roughened portion having no nanocolumn or low nanocolumns standing numerously on the non-nano-roughened portion and having a height that is smaller than 40 nm. The resin member is joined to the nano-roughened portion over the entire periphery with a resin material that forms the resin member filling gaps between the high nanocolumns standing numerously on the nano-roughened portion, and an interface of the metal member and the resin member between one side and the other side of the nano-roughed portion in a width direction is hermetically sealed.

In the metal-resin joint described above, the continuous band-shaped (band-shaped and continuous) recess arranged portion in which numerous bowl-shaped recesses are arranged is provided on the continuous band-shaped resin joined portion as a part of the metal surface of the metal member. The recess arranged portion includes the non-nano-roughened portion having no nanocolumns or low nanocolumns (that are not properly nano-roughened at the nano level) standing numerously thereon, but includes the nano-roughened portion in which high nanocolumns (that are properly nano-roughened at the nano level) stand numerously on the continuous band-shaped area. The resin member is joined to the nano-roughened portion over the entire periphery such that gaps between the high nanocolumns standing numerously on the nano-roughened portion are filled with the resin material, and a hermetic seal is provided along the interface between the metal member and the resin member between one side and the other side of the nano-roughened portion in the width direction. Thus, in the metal-resin joint described above, a good seal can be provided between the metal member and the resin member, even in the presence of the non-nano-roughened portion where nano-roughing was not properly performed in the recess arranged portion.

The “recess arranged portion” may be a portion of the resin joined portion or the entire area of the resin joined portion. The “continuous band-shaped nano-roughened portion” preferably has a dimension of at least 150 μm in the width direction. Thus, a hermetic seal can be more effectively provided at the interface between one side and the other side of the nano-roughened portion in the width direction.

The main component of the “metal member” is preferably aluminum, copper, iron, tin, titanium, zinc, chromium, or nickel. Thus, the recess arranged portion in which numerous bowl-shaped recesses are arranged can be easily provided in the resin joined portion of the metal member.

(2) In the metal-resin joint described above in (1), the metal member may be a bar-shaped member in which the metal surface has an outer peripheral surface, and the metal member has the recess arranged portion including the nano-roughened portion of the continuous band shape surrounding the outer peripheral surface. The resin member may be a continuous member surrounding the outer peripheral surface of the metal member, and the resin member may be joined to the nano-roughened portion of the continuous band shape over the entire periphery.

In the metal-resin joint described above, the metal member is the bar-shaped member, and the resin member is the continuous member surrounding the outer peripheral surface of the metal member. The recess arranged portion including the continuous band-shaped nano-roughened portion surrounding the outer peripheral surface is provided on the metal member, and the resin member is joined to the continuous band-shaped nano-roughened portion over the entire periphery. With this arrangement, the interface between the outer peripheral surface of the metal member and the resin member can be hermetically separated, with respect to the continuous band-shaped nano-roughened portion as a boundary, into one side and the other side of the nano-roughened portion in the width direction, namely, into one side and the other side of the metal member in the axial direction.

(3) In the metal-resin joint described above in (1), the metal member may be configured to have a through hole, and the metal surface may have an opening peripheral surface surrounding an opening edge of the through hole, the opening peripheral surface having the recess arranged portion including the nano-roughened portion of the continuous band shape surrounding the opening edge. The resin member may be joined to the nano-roughened portion of the continuous band shape surrounding the opening edge over the entire periphery.

In the metal-resin joint described above, the metal member is configured to have the through hole. The recess arranged portion including the continuous band-shaped nano-roughened portion surrounding the opening edge is provided on the opening peripheral surface as a part of the metal surface of the metal member, and the resin member is joined to the continuous band-shaped nano-roughened portion surrounding the opening edge over the entire periphery. With this arrangement, the interface between the opening peripheral surface of the metal member and the resin member can be hermetically separated, with respect to the continuous band-shaped nano-roughened portion as a boundary, into one side and the other side of the nano-roughened portion in the width direction, namely, into the inner side and the outer side of the opening peripheral surface.

(4) Another aspect of the disclosure is a method of manufacturing a metal-resin joint including a metal member having a continuous band-shaped resin joined portion on a metal surface, and a resin member joined to the resin joined portion over the entire periphery in a circumferential direction of the resin joined portion to be fixed to the metal member, wherein the resin joined portion of the metal member has a recess arranged portion in which numerous bowl-shaped recesses each having a diameter of 30 μm to 300 μm and dented in the form of a bowl are arranged while partially overlapping, the recess arranged portion having a continuous band shape extending over the entire periphery in the circumferential direction, wherein the recess arranged portion includes a nano-roughened portion having a continuous band shape extending over the entire periphery in the circumferential direction, the nano-roughened portion having nanocolumns formed by joining particles derived from a metal that forms the metal member and having a diameter of 100 nm or less together like strings of beads, into the form of columns, the nanocolumns being high nanocolumns standing numerously on the nano-roughened portion and having a height of 40 nm or greater, wherein the recess arranged portion includes a non-nano-roughened portion having no nanocolumn or low nanocolumns standing numerously on the non-nano-roughened portion and having a height that is smaller than 40 nm, wherein the resin member is joined to the nano-roughened portion over the entire periphery with a resin material that forms the resin member filling gaps between the high nanocolumns standing numerously on the nano-roughened portion, and wherein an interface of the metal member and the resin member between one side and the other side of the nano-roughed portion in a width direction is hermetically sealed. The method includes recess forming of forming the numerous bowl-shaped recesses in the resin joined portion of the metal member by intermittently applying a pulsed laser beam to the resin joined portion while shifting an irradiation position, to form the recess arranged portion, and resin forming of forming the resin member joined to the metal member after the recess forming. In the recess forming, the pulsed laser beam is caused to travel in a consecutively forming direction that intersects a width direction of the resin joined portion, to form a consecutive recess area in which the bowl-shaped recesses are arranged in a row in the consecutively forming direction while partially overlapping, and formation of the consecutive recess area is repeated a plurality of times in a row arrangement direction perpendicular to the consecutively forming direction, to arrange a plurality of rows of the consecutive recess areas in the row arrangement direction while partially overlaying the consecutive recess areas to form the recess arranged portion including the nano-roughened portion. In the resin forming, the resin member hermetically joined to the nano-roughened portion over the entire periphery and joined to the resin joined portion over the entire periphery is formed with the resin material filling gaps between the high nanocolumns standing numerously on the nano-roughened portion.

In the method of manufacturing the metal-resin joint described above, the pulsed laser beam is caused to travel in the recess forming to form a plurality of rows of consecutive recess areas in each of which a plurality of bowl-shaped recesses is arranged in a row in the consecutively forming direction, in the row arrangement direction, thereby to form the recess arranged portion including the nano-roughened portion. Thus, the nano-roughened portion can be easily formed. Then, in the resin forming, the resin member is formed with the resin material filling gaps between the high nanocolumns standing numerously on the nano-roughened portion, so that the resin member hermetically joined to the nano-roughened portion over the entire periphery can be easily formed.

In the “resin forming”, the resin member is formed by, for example, forming (molding) the resin member by insert molding using the metal member, or forming the resin member by applying a liquid resin material to the resin joined portion of the metal member and allowing the resin material to dry.

(5) In the method of manufacturing the metal-resin joint described in (4), the recess forming may comprise forming the recess arranged portion including the nano-roughened portion, by forming the consecutive recess areas in a multi-stage continuous band shape or in a multi-layered spiral shape.

In the method of manufacturing the metal-resin joint described above, in the recess forming, the recess arranged portion including the nano-roughened portion is formed by forming the consecutive recess areas in a multi-stage continuous band shape or in a multi- layered spiral shape, so that the continuous band-shaped nano-roughened portion can be easily formed in the resin joined portion of the metal member.

### BRIEF DESCRIPTION OF THE DRAWINGS

FIG. 1 is a perspective view of a battery having first metal-resin joints and second metal-resin joints according to one embodiment;

FIG. 2 is a partially broken cross-sectional view of the battery having the first metal-resin joints and the second metal-resin joints according to the embodiment, taken along the battery height direction and the battery width direction;

FIG. 3 is a partially enlarged cross-sectional view of a resin member and its vicinity of the battery having the first metal-resin joints and the second metal-resin joints according to the embodiment, which view is taken along the battery height direction and the battery thickness direction;

FIG. 4 is a partially enlarged plan view of a resin joined portion (part A and part B in FIG. 3) according to the embodiment;

FIG. 5 is a partially enlarged cross-sectional view of a nano-roughened portion according to the embodiment;

FIG. 6 is a partially enlarged cross-sectional view showing high nanocolumns standing numerously on a bowl-shaped recess in the nano-roughened portion according to the embodiment;

FIG. 7 is a partially enlarged cross-sectional view of a non-nano-roughened portion according to the embodiment;

FIG. 8 is a partially enlarged cross-sectional view showing low nanocolumns standing numerously on a bowl-shaped recess in the non-nano-roughened portion according to the embodiment;

FIG. 9 is a flowchart of a method of manufacturing the battery including a method of manufacturing a metal-resin joint according to the embodiment;

FIG. 10 is an explanatory view in connection with the method of manufacturing the metal-resin joint according to the embodiment, showing the manner of forming a plurality of bowl-shaped recesses by passing a pulsed laser beam over in a first recess forming step (a second recess forming step);

FIG. 11A is an explanatory view of a resin forming step in connection with the method of manufacturing the metal-resin joint according to the embodiment, showing positive and negative terminal members respectively inserted in through holes of a case lid member; and

FIG. 11B is an explanatory view of the resin forming step in connection with the method of manufacturing the metal-resin joint according to the embodiment, showing a pair of resin members molded respectively.

### DETAILED DESCRIPTION OF THE EXEMPLARY EMBODIMENTS

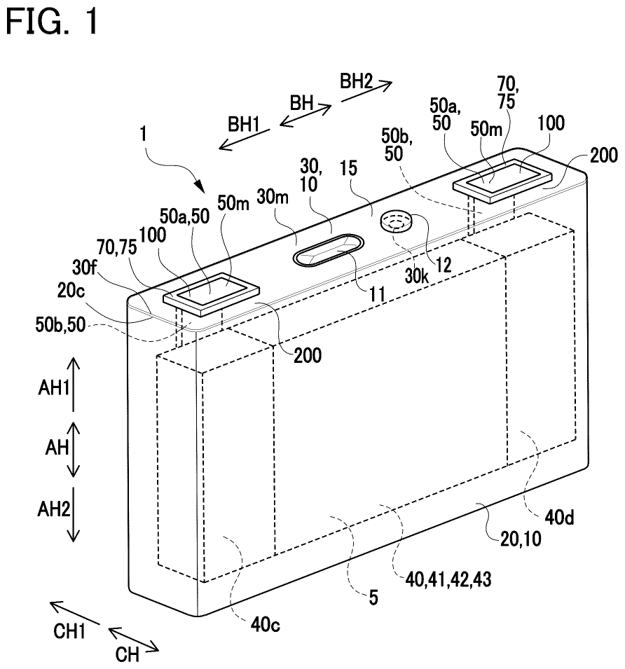

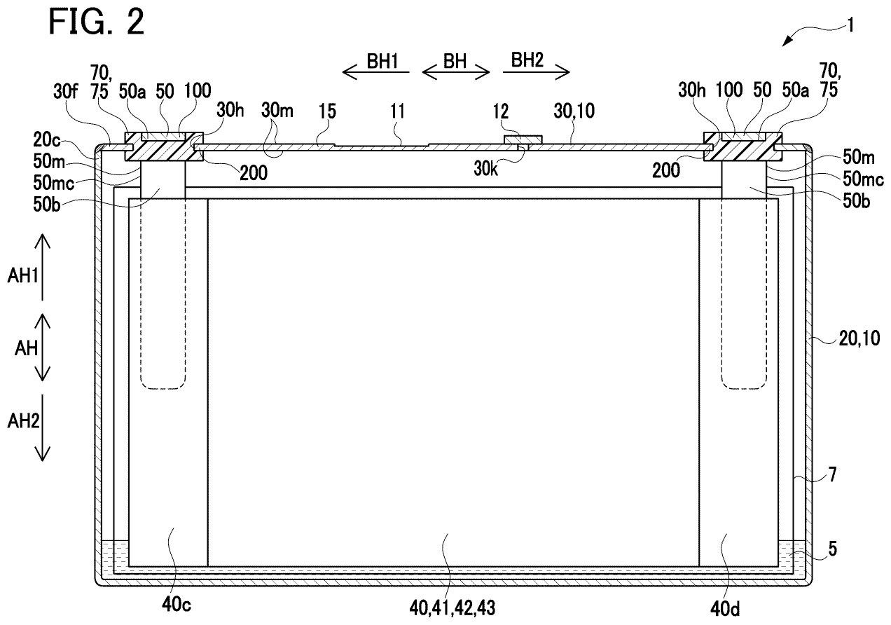

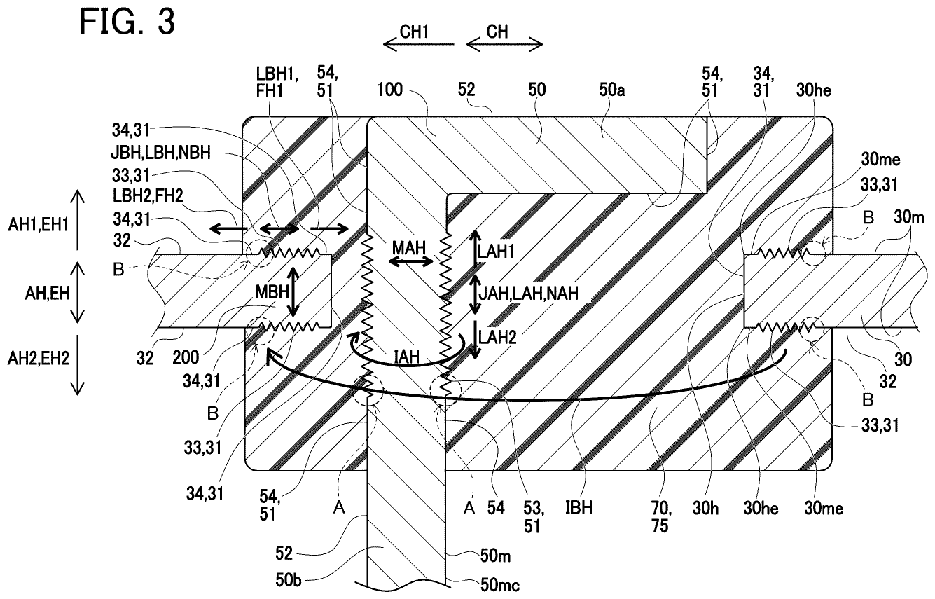

In the following, one embodiment of the disclosure will be described with reference to the drawings. FIG. 1 is a perspective view of a battery (a power storage device) 1 having first metal-resin joints 100 and second metal-resin joints 200 according to the embodiment, and FIG. 2 is a partially broken cross-sectional view of the battery 1. FIG. 3 is a partially enlarged cross-sectional view of a resin member 70 and its vicinity of the battery 1. In the following description, the battery height direction AH, battery width direction BH, and battery thickness direction CH of the battery 1 are defined as the directions indicated in FIG. 1 through FIG. 3.

The battery 1 is a sealed lithium-ion secondary battery having a rectangular (rectangular parallelepiped) shape, which is installed on a vehicle, such as a hybrid vehicle, plug-in hybrid vehicle, or an electric vehicle. The battery 1 is comprised of a case 10 that consists of a case body 20 and a case lid member 30, an electrode body 40 housed in the case 10, positive and negative terminal members 50 respectively fixed to the case 10 via resin members 70, and so forth. In the case 10, the electrode body 40 is covered with a bag-like insulating holder 7 made from an insulating film. The case 10 also contains electrolyte 5, and the electrode body 40 is impregnated with a part of the electrolyte 5, while the rest of the electrolyte 5 is collected and kept on a bottom wall of the case 10.

The battery 1 includes two first metal-resin joints 100 and two second metal-resin joints 200. Specifically, each set of the positive and negative terminal members (one example of the metal members of the disclosure) 50 and the resin members 70 joined and fixed to the respective terminal members 50 is the first metal-resin joint 100 (which will also be simply referred to as “metal-resin joint 100”). Each set of the case lid member (one example of the metal member of the disclosure) 30 and the resin members 70 of the positive and negative electrodes joined and fixed to the case lid member 30 is the second metal-resin joint 200 (which will also be simply referred to as “metal-resin joint 200”).

The case 10 is shaped like a rectangular parallelepiped box and made of metal (aluminum in this embodiment). The case 10 consists of a case body 20 that is in the form of a rectangular tube with a bottom and a rectangular opening portion 20c and houses the electrode body 40 therein, and a case lid member 30 in the form of a rectangular plate that closes the opening portion 20c of the case body 20. The opening portion 20c of the case body 20 and a peripheral portion 30f of the case lid member 30 are hermetically welded together over the entire periphery thereof. The case lid member 30 is provided with a safety valve 11 that breaks and opens when the internal pressure of the case 10 exceeds the valve opening pressure. The case lid member 30 is also provided with a liquid inlet 30k, and the liquid inlet 30k is hermetically sealed with a disc-shaped sealing member 12 made of aluminum.

The electrode body 40 is of a rectangular parallelepiped, stacked type, and has a plurality of rectangular positive electrode sheets 41 and a plurality of rectangular negative electrode sheets 42 alternately stacked in the battery thickness direction CH via rectangular separators 43 each made from a porous resin film. In the electrode body 40, on one side BH1 in the battery width direction BH, current collecting foils of the respective positive electrode sheets 41 are superposed in the battery thickness direction CH to form a positive current collector 40c. The positive current collector 40c is conductively connected to the terminal member 50 of the positive electrode (which will be described below). Also in the electrode body 40, on the other side BH2 in the battery width direction BH, current collecting foils of the respective negative electrode sheets 42 are superposed in the battery thickness direction CH to form a negative current collector 40d. The negative current collector 40d is conductively connected to the terminal member 50 of the negative electrode (which will be described below).

Portions of the case lid member 30 near its ends on one side BH1 and the other side BH2 in the battery width direction BH respectively have rectangular through holes 30h that extend through the case lid member 30. The terminal member 50 of the positive electrode made of aluminum is inserted through the through hole 30h on the one side BH1, and the terminal member 50 is fixed to the case lid member 30 while being insulated from the case lid member 30 via the resin member 70. Also, the terminal member 50 of the negative electrode made of copper is inserted through the through hole 30h on the other side BH2, and the terminal member 50 is fixed to the case lid member 30 while being insulated from the case lid member 30 via the resin member 70.

Each terminal member 50 is formed by pressing a metal plate (an aluminum plate on the positive electrode and a copper plate on the negative electrode), and has a bar shape extending in the axial direction EH (the same direction as the battery height direction AH in this embodiment). The terminal member 50 consists of a terminal top plate 50a in the form of a rectangular plate extending in the battery width direction BH and the battery thickness direction CH and located on one side EH1 (the upper side AH1 in the battery height direction AH relative to the case lid member 30) in the axial direction EH, and a terminal extension 50b that extends from the terminal top plate 50a toward the other side EH2 (the lower side AH2 in the battery height direction AH) in the axial direction EH. The terminal extension 50b is bent at an end portion of the terminal top plate 50a on one side CH1 in the battery thickness direction CH and extends to the lower side AH2 through the through hole 30h of the case lid member 30, and further through the resin member 70. The terminal extension 50b of the positive electrode is welded at its distal end portion on the lower side AH2 to the positive current collector 40c of the electrode body 40, to be conductively connected to the positive current collector 40c. The terminal extension 50b of the negative electrode is welded at its distal end portion on the lower side AH2 to the negative current collector 40d of the electrode body 40, to be conductively connected to the negative current collector 40d.

A metal surface 50m of the terminal member 50 has a resin joined portion 51 that is a continuous band-shaped portion to which the resin member 70 is joined, and non-resin-joined portions 52 to which the resin member 70 is not joined. More specifically, the inner surface that faces to the lower side AH2 and four side surfaces, as a part of the surfaces of the terminal top plate 50a, and a portion of the outer peripheral surface 50mc of the terminal extension 50b located inside the resin member 70 on the upper side AH1 provide the resin joined portion 51. On the other hand, the top surface that faces to the upper side AH1, as a part of the surfaces of the terminal top plate 50a, and a portion of the outer peripheral surface 50mc of the terminal extension 50b which protrudes from the resin member 70 to the lower side AH2 and is exposed are the non-resin-joined portions 52.

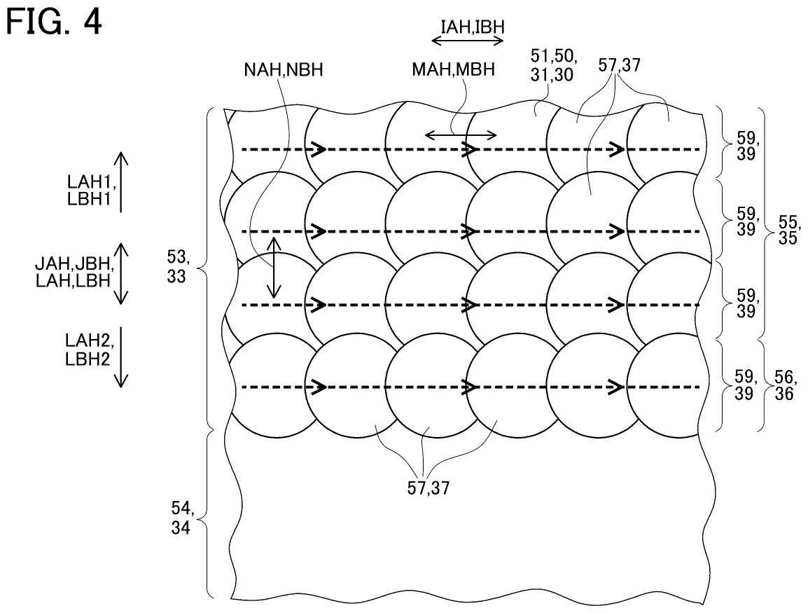

Next, the resin joined portion 51 will be described in detail (see FIG. 4 through FIG. 8). FIG. 4 is an enlarged view of part A, surrounded by a dashed line in FIG. 3, of the resin joined portion 51. The resin joined portion 51 of the terminal member 50 consists of a recess arranged portion 53 in which numerous bowl-shaped recesses 57 are arranged, and non-recess-arranged portions 54 in which no bowl-shaped recesses 57 are arranged. Specifically, the recess arranged portion 53 is a rectangular continuous band-shaped portion of the resin joined portion 51, which surrounds the outer peripheral surface 50mc and is provided by a middle portion as viewed in the battery height direction AH of the terminal extension 50b located inside the resin member 70. On the other hand, the non-recess-arranged portions 54 are a portion of the resin joined portion 51 provided by the terminal top plate 50a and portions of the resin joined portion 51 provided by the upper side AH1 and the lower side AH2 of the terminal extension 50b located inside the resin member 70.

The recess arranged portion 53 has a rectangular continuous or endless band shape extending in the battery height direction AH, over the entire periphery of the resin joined portion 51 in the circumferential direction IAH (the circumferential direction along the battery width direction BH and the battery thickness direction CH in this embodiment). In the recess arranged portion 53, numerous bowl-shaped recesses 57 that are dented in the shape of bowls or impact craters and have a diameter Db of 30 μm to 300 μm are arranged in lines while partially overlapping (the diameter Db is generally equal to 80 μm in the terminal member 50 of the positive electrode and the diameter Db is generally equal to 75 μm in the terminal member 50 of the negative electrode).

Furthermore, the recess arranged portion 53 consists of a nano-roughened portion 55 and a non-nano-roughened portion 56. Specifically, the non-nano-roughened portion 56 is a rectangular continuous band-shaped portion that forms an end portion on the lower side AH2 of the rectangular continuous band-shaped recess arranged portion 53 extending in the battery height direction AH. The nano-roughened portion 55 is a rectangular continuous band-shaped portion that forms a portion of the recess arranged portion 53 on the upper side AH1 relative to the non-nano-roughened portion 56.

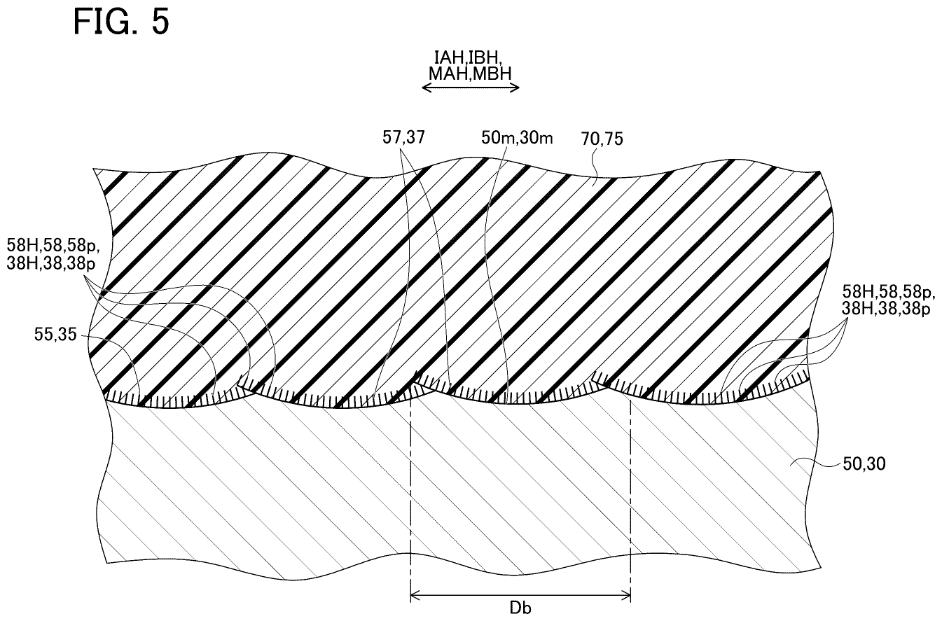

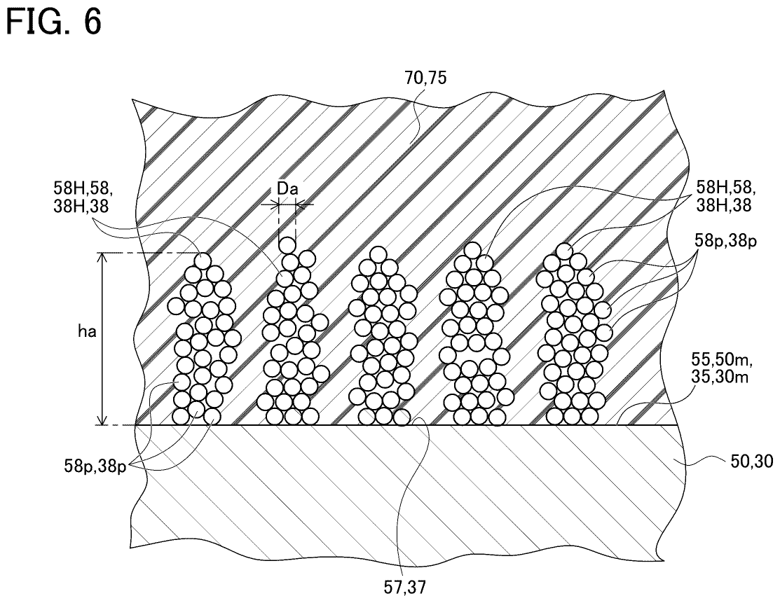

In the nano-roughened portion 55, nanocolumns 58 into which particles 58p derived from metal that forms the terminal member 50 are joined together like strings of beads, in particular, high nanocolumns 58H having a height ha of 40 nm or greater (the height ha is generally equal to 200 nm in this embodiment), stand together in large numbers (see FIG. 5 and FIG. 6). The metal that forms the terminal member 50 of the positive electrode is aluminum, and the nanocolumn 58 of the positive electrode consists of the particles 58p made of aluminum and aluminum oxide. The metal that forms the terminal member 50 of the negative electrode is copper, and the nanocolumn 58 of the negative electrode consists of the particles 58p made of copper and copper oxide. The diameter Da of the particles 58p of the positive and negative electrodes is equal to or smaller than 100 nm (the diameter Da is generally equal to 30 nm in this embodiment).

On the other hand, the above-mentioned nanocolumns 58 stand together in large

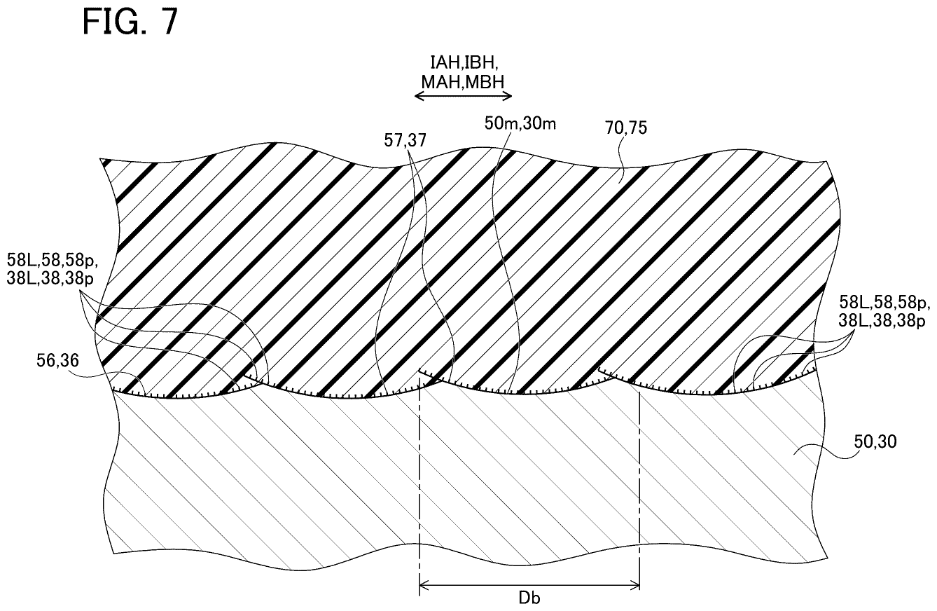

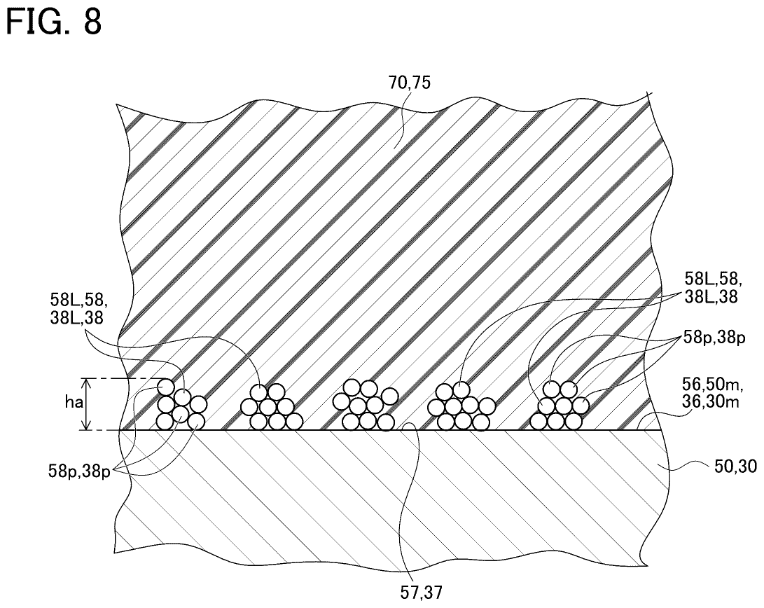

numbers in the non-nano-roughened portion 56, but the nanocolumns 58 are low nanocolumns 58L of which the height ha is smaller than 40 nm (the height ha is smaller than 20 nm in this embodiment) (see FIG. 7 and FIG. 8).

Next, resin joined portions 31 of the case lid member 30 will be described in detail (see FIG. 3 through FIG. 8). FIG. 4 is an enlarged view of part B, surrounded by a dashed line in FIG. 3, of a resin joined portion 31. The resin joined portions 31 are continuous band-shaped portions of the metal surface 30m of the case lid member 30 to which the respective resin members 70 are joined, and non-resin-joined portions 32 are portions of the metal surface 30m to which the resin members 70 are not joined. More specifically, the metal surface 30m of the case lid member 30 includes a pair of rectangular continuous band-shaped opening peripheral surfaces 30me surrounding a pair of opening edges 30he of the through hole 30h of the positive electrode, and a pair of rectangular continuous band-shaped opening peripheral surfaces 30me surrounding a pair of opening edges 30he of the through hole 30h of the negative electrode. Each through hole 30h extends in the battery height direction AH, and one of the opening edges 30he and one of the opening peripheral surfaces 30me are located on the upper side AH1, while the other opening edge 30he and the other opening peripheral surface 30me are located on the lower side AH2. Of the metal surface 30m of the case lid member 30, the pair of opening peripheral surfaces 30me and an inner circumferential surface of the through hole 30h connecting the surfaces 30me are the resin joined portions 31. On the other hand, portions of the metal surface 30m of the case lid member 30 other than the opening peripheral surfaces 30me and the inner circumferential surface of the through hole 30h are the non-resin-joined portions 32.

The resin joined portion 31 of the case lid member 30 consists of recess arranged portions 33 in which numerous bowl-shaped recesses 37 are arranged and non-recess-arranged portions 34 in which no bowl-shaped recesses 37 are arranged. Specifically, in the resin joined portion 31, radially middle portions of the pair of opening peripheral surfaces 30me are the recess arranged portions 33, and portions of the opening peripheral surfaces 30me on the inner side FH1 and the outer side FH2 as viewed in the radial direction, and the inner circumferential surface of the through hole 30h are the non-recess-arranged portions 34. Each of the recess arranged portions 33 has a rectangular continuous band shape extending in the battery width direction BH and the battery thickness direction CH, over the entire periphery of the resin joined portion 31 in the circumferential direction IBH (the circumferential direction along the battery width direction BH and the battery thickness direction CH in this embodiment). In the recess arranged portion 33, numerous bowl-shaped recesses 37 that are dented in the shape of bowls or impact craters and have a diameter Db of 30 μm to 300 μm (the diameter Db is generally equal to 80 μm in this embodiment) are arranged in lines while partially overlapping.

Furthermore, each of the recess arranged portions 33 consists of a nano-roughened portion 35 and a non-nano-roughened portion 36. Specifically, the non-nano-roughened portion 36 is a rectangular continuous band-shaped portion that forms an edge portion on the outer side FH2 of the recess arranged portion 33. The nano-roughened portion 35 is a rectangular continuous band-shaped portion that forms a portion of the recess arranged portion 33 on the inner side FH1 relative to the non-nano-roughened portion 36.

In the nano-roughened portion 35, nanocolumns 38 into which particles 38p derived from metal that forms the case lid member 30 are joined together like strings of beads, in particular, high nanocolumns 38H having a height ha of 40 nm or greater (the height ha is generally equal to 200 nm in this embodiment), stand together in large numbers (see FIG. 5 and FIG. 6). The metal that forms the case lid member 30 is aluminum, and the nanocolumn 38 consists of the particles 38p made of aluminum and aluminum oxide. The diameter Da of the particles 38p is equal to or smaller than 100 nm (the diameter Da is generally equal to 30 nm in this embodiment).

On the other hand, the above-mentioned nanocolumns 38 stand together in large numbers in the non-nano-roughened portion 36, but the nanocolumns 38 are low nanocolumns 38L of which the height ha is smaller than 40 nm (the height ha is smaller than 20 nm in this embodiment) (see FIG. 7 and FIG. 8).

Next, the resin member 70 will be described. The resin member 70 is insert molded using a resin material 75 including a thermoplastic main resin (specifically, polyphenylene sulfide (PPS)), a thermoplastic elastomer, and a filler (specifically, a fibrous glass filler). The resin member 70 is hermetically joined and fixed to the case lid member 30 and the terminal member 50, respectively, while insulating the case lid member 30 and the terminal member 50 from each other.

In the first metal-resin joint 100 constituted by the terminal member 50 and the resin member 70, the resin member 70 has a frame-like shape surrounding the outer peripheral surface 50mc of the terminal member 50, and is joined to the continuous band-shaped resin joined portion 51 of the outer peripheral surface 50mc over the entire periphery in the circumferential direction IAH and fixed to the terminal member 50. More specifically, the resin member 70 is joined to the continuous band-shaped nano-roughened portion 55 over the entire periphery in the circumferential direction IAH, such that gaps between the high nanocolumns 58H standing numerously on the nano-roughened portion 55 of the recess arranged portion 53 of the resin joined portion 51 are filled with the above-mentioned resin material 75. With this arrangement, the interface of the terminal member 50 and the resin member 70 between one side LAH1 (the same direction as the upper side AH1 in this embodiment) and the other side LAH2 (the same direction as the lower side AH2 in this embodiment) in the width direction LAH (the same direction as the battery height direction AH in this embodiment) of the nano-roughened portion 55 is hermetically sealed.

In the second metal-resin joint 200 constituted by the case lid member 30 and the resin member 70, the resin member 70 is joined to the continuous band-shaped resin joined portion 31 of the metal surface 30m of the case lid member 30 over the entire periphery in the circumferential direction IBH and fixed to the case lid member 30. More specifically, the resin joined portion 31 of the case lid member 30 has a pair of continuous band-shaped recess arranged portions 33 surrounding the opening edges 30he on the upper side AH1 and the lower side AH2 of the through hole 30h, as described above. The resin member 70 is joined to each of the pair of nano-roughened portions 35 over the entire periphery in the circumferential direction IBH such that gaps between the high nanocolumns 38H standing numerously on the nano-roughened portions 35 of the recess arranged portions 33 are filled with the above-mentioned resin material 75. With this arrangement, the interface of the case lid member 30 and the resin member 70 between one side LBH1 (the inner side FH1) and the other side LBH2 (the outer side FH2) in the width direction LBH (the same direction as the radial direction of the through hole 30h in this embodiment) of each nano-roughened portion 35 is hermetically sealed.

In the metal-resin joints 100, 200 of this embodiment, the continuous band-shaped recess arranged portions 53, 33 in which numerous bowl-shaped recesses 57, 37 are arranged are provided on the continuous band-shaped resin joined portions 51, 31 of the metal surfaces 50m, 30m of the metal members (the terminal member 50 and the case lid member 30). The recess arranged portions 53, 33 include the non-nano-roughened portions (not properly nano-roughened) 56, 36 on which the low nanocolumns 58L, 38L stand together in large numbers, but include the nano-roughened portions 55, 35 (properly nano-roughened) as continuous band-shaped areas on which the high nanocolumns 58H, 38H stand together in large numbers. The resin member 70 is joined to the nano-roughened portions 55, 35 over the entire periphery such that gaps between the high nanocolumns 58H, 38H standing numerously on the nano-roughened portions 55, 35 are filled with the resin material 75, and the interfaces between the terminal member 50 and case lid member 30, and the resin member 70, between one side LAH1, LBH1 and the other side LAH2, LBH2 in the width direction LAH, LBH of the nano-roughened portions 55, 35 are hermetically sealed. With this arrangement, in the metal-resin joints 100, 200, even in the presence of the non-nano-roughened portions 56, 36 that are not properly nano-roughened in the recess arranged portions 53, 33, good seals can be respectively established between the terminal member 50 and case lid member 30, and the resin member 70.

In the first metal-resin joint 100, the terminal member 50 has a bar-like shape, and the resin member 70 has a frame-like shape surrounding the outer peripheral surface 50mc of the terminal member 50. The terminal member 50 is provided with the recess arranged portion 53 including the continuous band-like nano-roughened portion 55 surrounding the outer peripheral surface 50mc, and the resin member 70 is joined to the continuous band-like nano-roughened portion 55 over the entire periphery. Thus, the interface between the outer peripheral surface 50mc of the terminal member 50 and the resin member 70 can be hermetically separated, with respect to the continuous band-shaped nano-roughened portion 55 as a boundary, into one side LAH1 and the other side LAH2 in the width direction LAH of the nano-roughened portion 55, namely, into one side EH1 and the other side EH2 in the axial direction EH of the terminal member 50.

In the second metal-resin joint 200, the case lid member 30 is configured to have the through hole 30h. The recess arranged portions 33 including the continuous band-shaped nano-roughened portions 35 surrounding the opening edges 30he are respectively provided on the pair of opening peripheral surfaces 30me as part of the metal surface 30m of the case lid member 30, and the resin member 70 is joined to the pair of continuous band-shaped nano-roughened portions 35 surrounding the opening edges 30he over the entire periphery. Thus, the interface between each of the opening peripheral surfaces 30me of the case lid member 30 and the resin member 70 can be hermetically separated, with respect to each of the continuous band-shaped nano-roughened portions 35 as a boundary, into one side LBH1 and the other side LBH2 in the width direction LBH of the nano-roughened portion 35, namely, into the inner side FH1 and the outer side FH2 of the opening peripheral surface 30me.

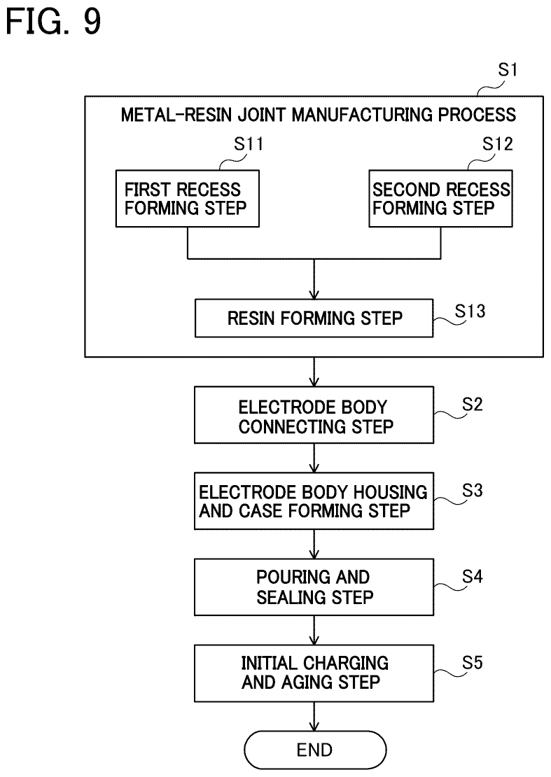

Next, a method of manufacturing the battery 1 including a method of manufacturing the metal-resin joints 100, 200 will be described (see FIG. 9 through FIG. 11). First, a case lid member (one example of the metal member of the disclosure) 30Z before roughening is prepared. The case lid member 30Z before roughening is obtained by press working using an aluminum plate. Terminal members (one example of the metal members of the disclosure) 50Z before roughening are also prepared. The terminal member 50Z before roughening is obtained by press working using a metal plate (an aluminum plate for the positive electrode, a copper plate for the negative electrode).

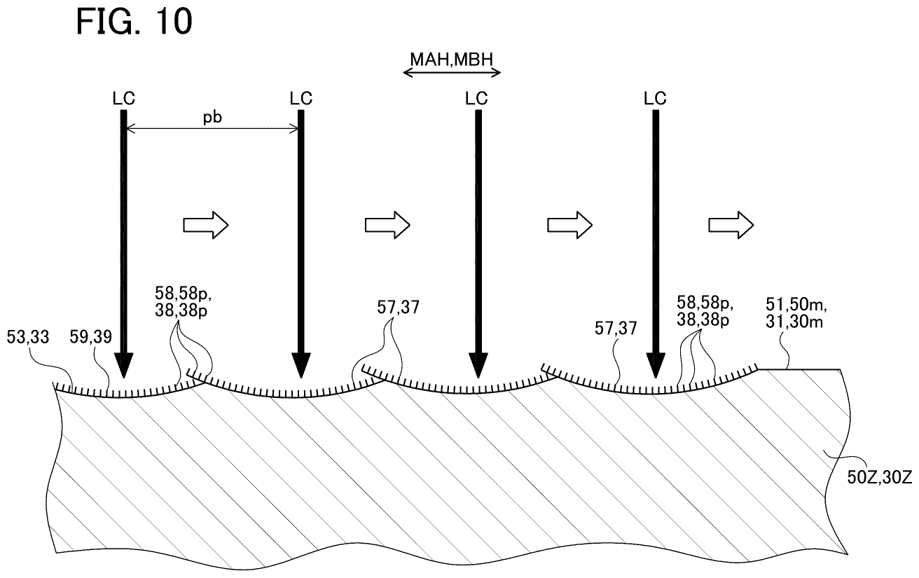

In the “first recess forming step (which will also be simply referred to as “recess forming step”) S11 of the “metal-resin joint manufacturing process S1”, a pulsed laser beam LC is intermittently applied to the resin joined portion 51 of the outer peripheral surface 50mc of the metal surface 50m of the above-mentioned terminal member 50Z while shifting the irradiation position to form numerous bowl-shaped recesses 57 and thus form the recess arranged portion 53 (see FIG. 10 and FIG. 4). In FIG. 4, the direction of travel of the pulsed laser beam LC (the direction of advance of the irradiation position) is indicated by dotted arrows.

Specifically, the pulsed laser beam LC is caused to travel over the entire periphery in the circumferential direction IAH, in a consecutively forming direction MAH (the battery width direction BH and the battery thickness direction CH in a state where the battery 1 is constructed) that intersects (at right angles in this embodiment) the width direction JAH of the resin joined portion 51, to form a rectangular continuous band-shaped consecutive recess area 59 in which a plurality of bowl-shaped recesses 57 is arranged in a row in the consecutively forming direction MAH while partially overlapping each other. Furthermore, the formation of the consecutive recess area 59 is repeated to form a plurality of rows (ten rows in this embodiment) in a row arrangement direction NAH (the battery height direction AH in the state where the battery 1 is constructed) perpendicular to the consecutively forming direction MAH, and the ten rows of the consecutive recess areas 59 are partially superposed on each other in the row arrangement direction NAH, to form the multi-stage rectangular continuous band-shaped recess arranged portion 53. In this connection, the consecutive recess areas 59 may be formed in a multi-layered spiral shape to form the recess arranged portion 53.

Of the ten rows of the consecutive recess areas 59 that constitute the recess arranged portion 53, the consecutive recess area 59 formed last (the consecutive recess area 59 located on the lowest side AH2 in the state where the battery 1 is constructed) has small nanocolumns 58 standing numerously, which are low nanocolumns 58L; therefore, the last consecutive recess area 59 is the non-nano-roughened portion 56. The dimension of the non-nano-roughened portion 56 as measured in the width direction LAH is generally equal to 75 μm in the terminal member 50 of the positive electrode, and is generally equal to 60 μm in the terminal member 50 of the negative electrode.

On the other hand, the remaining nine rows of the consecutive recess areas 59 (the nine rows of the consecutive recess areas 59 on the upper side AH1 in the state where the battery 1 is constructed) have large nanocolumns 58 standing numerously, which are high nanocolumns 58H; therefore, the rectangular continuous band-shaped nano-roughened portion 55 is formed by the nine rows of the consecutive recess areas 59. The dimension of the nano-roughened portion 55 as measured in the width direction LAH is generally equal to 675 μm in the terminal member 50 of the positive electrode, and is generally equal to 540 μm in the terminal member 50 of the negative electrode.

In this embodiment, the irradiation conditions of the laser beam for the positive electrode are set as follows: the wavelength is 1064 nm, the peak power is 5 kW, the pulse width is 150 ns, the pitch pb is 75 μm, and the spot diameter Db is 80 μm. The irradiation conditions of the laser beam for the negative electrode are set as follows: the wavelength is 1064 nm, the peak power is 20 kW, the pulse width is 50 ns, the pitch pb is 60 μm, and the spot diameter Db is 75 μm.

In a circular region of the resin joined portion 51 as seen in plan view, which region is irradiated with the pulsed laser beam LC, metal (aluminum on the positive electrode, copper on the negative electrode) near the surface is melted and further turns into vapor. As the temperature of the vapor then decreases, the vapor turns into the particles 58p (the particles 58p of aluminum and aluminum oxide on the positive electrode, the particles 58p of copper and copper oxide on the negative electrode), which are deposited on the resin joined portion 51. By intermittently applying the pulsed laser beam LC to the resin joined portion 51 while shifting the irradiation position, the particles 58p are deposited and joined together like strings of beads, into the form of columns, to form the nanocolumns 58 standing together in large numbers. It may be considered that, in the last formed consecutive recess area 59, the height ha of the nanocolumns 58 is reduced because the amount of the particles 58p deposited from the surroundings is small.

Meanwhile, in the “second recess forming step (which will also be simply referred to as “recess forming step”) S12 (see FIG. 9) of the metal-resin joint manufacturing process S1, a pulsed laser beam LC is intermittently applied to the resin joined portion 31 of each of the pair of opening peripheral surfaces 30me of the metal surface 30m of the case lid member 30Z described above while shifting the irradiation position, to form numerous bowl-shaped recesses 37 and thus form the recess arranged portion 33 (see FIG. 10 and FIG. 4).

Specifically, the pulsed laser beam LC is caused to travel over the entire periphery in the circumferential direction IBH, in a consecutively forming direction MBH (the battery width direction BH and the battery thickness direction CH in the state where the battery 1 is constructed) that intersects (at right angles in this embodiment) the width direction JBH of the resin joined portion 31, to form a rectangular continuous band-shaped consecutive recess area 39 in which a plurality of bowl-shaped recesses 37 is arranged in a row in the consecutively forming direction MBH while partially overlapping each other. Furthermore, the formation of the consecutive recess area 39 is repeated to form a plurality of rows (five rows in this embodiment) in a row arrangement direction NBH (the radial direction of the through hole 30h) perpendicular to the consecutively forming direction MBH, and the five rows of the consecutive recess areas 39 are partially superposed on each other in the row arrangement direction NBH, to form the multi-stage rectangular continuous band-shaped recess arranged portion 33. In this connection, the consecutive recess areas 39 may be formed in a multi-layered spiral shape to form the recess arranged portion 33.

Of the five rows of the consecutive recess areas 39 that constitute the recess arranged portion 33, the consecutive recess area 39 formed last (the consecutive recess area 39 located on the radially outermost side) has small nanocolumns 38 standing numerously, which are low nanocolumns 38L; therefore, the last consecutive recess area 39 is the non-nano-roughened portion 36. The dimension of the non-nano-roughened portion 36 as measured in the width direction LBH is generally equal to 75 μm.

On the other hand, the remaining four rows of the consecutive recess areas 39 located on the radially inner side have large nanocolumns 38 standing numerously, which are high nanocolumns 38H; therefore, the rectangular continuous band-shaped nano-roughened portion 35 is formed by the four rows of the consecutive recess areas 39. The dimension of the nano-roughened portion 35 as measured in the width direction LBH is generally equal to 300 μm. The laser irradiation conditions are substantially identical with those under which the laser beam is applied to the terminal member 50 of the positive electrode in the first recess forming step S11.

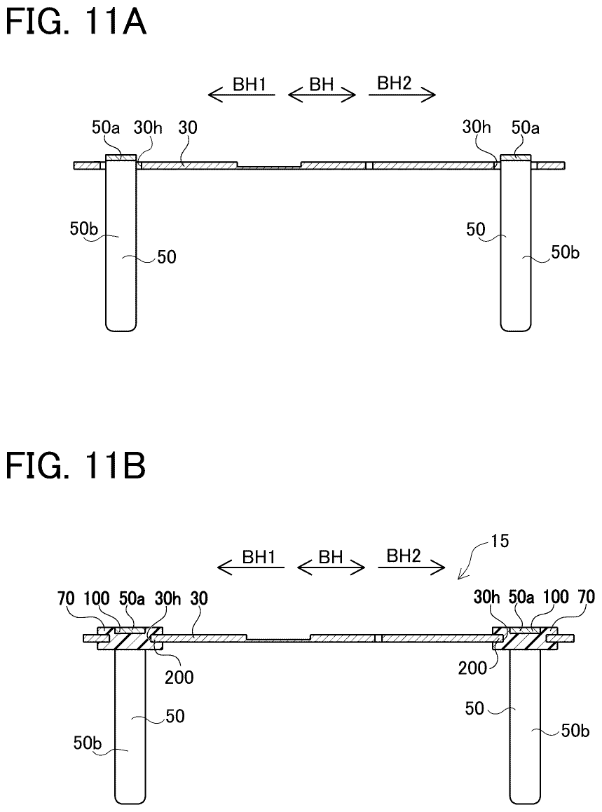

Next, in the “resin forming step S13” (see FIG. 9) of the metal-resin joint manufacturing process S1, the resin member 70 to which the terminal member 50 and the case lid member 30 are joined is formed. In this embodiment, a pair of resin members 70 are formed by insert molding (see FIG. 11), using the resin material 75 described above, in a condition where the positive and negative terminal members 50 are respectively inserted through the through holes 30h of the case lid member 30.

More specifically, the resin forming step S13 is carried out using a molding die (not shown) having an upper die and a lower die. First, the case lid member 30 is placed at a predetermined position of the lower die, and the positive and negative terminal members 50 are respectively inserted through the pair of through holes 30h of the case lid member 30 (see FIG. 11A). Then, the upper die is moved toward the lower die to close the molding die. The molten resin material 75 is then injected into two cavities of the molding die. At this time, the resin material 75 fills gaps between the high nanocolumns 58H standing numerously on the nano-roughened portions 55 of the terminal members 50, and also fills gaps between the high nanocolumns 38H standing numerously on the nano-roughened portions 35 of the case lid member 30.

Thus, the resin members 70 are respectively formed, which are hermetically joined to the nano-roughened portions 55 of the terminal members 50 over the entire periphery in the circumferential direction IAH to be joined to the resin joined portions 51 over the entire periphery and also hermetically joined to the nano-roughened portions 35 of the case lid member 30 over the entire periphery in the circumferential direction IBH to be joined to the resin joined portions 31 over the entire periphery (see FIG. 11B and FIG. 5 through FIG. 8). Then, a lid assembly 15 with the terminal members 50 fixed to the case lid member 30 via the resin members 70 is removed from the molding die. In this manner, the first metal-resin joint 100 consisting of the terminal member 50 and the resin member 70 and the second metal-resin joint 200 consisting of the case lid member 30 and the resin member 70 are formed.

Next, in the “electrode body connecting step S2” (see FIG. 9), the electrode body 40 obtained by stacking the positive electrode sheets 41, negative electrode sheets 42, and separators 43 is prepared, and the terminal extension 50b of the terminal member 50 of the positive electrode as a part of the lid assembly 15 described above is welded to the positive current collector 40c of the electrode body 40 (see FIG. 1 and FIG. 2). The terminal extension 50b of the terminal member 50 of the negative electrode as a part of the lid assembly 15 is also welded to the negative current collector 40d of the electrode body 40. The electrode body 40 is then wrapped with the bag-like insulating holder 7.

Next, in the “electrode body housing and case forming step S3”, the case body 20 is prepared, the electrode body 40 covered with the insulating holder 7 is inserted into the case body 20, and the opening portion 20c of the case body 20 is closed with the case lid member 30. Then, the opening portion 20c of the case body 20 and the peripheral portion 30f of the case lid member 30 are laser welded hermetically over the entire periphery to form the case 10 with the electrode body 40 housed inside.

Next, in the “pouring and sealing step S4”, the electrolyte 5 is poured into the case 10 through the liquid inlet 30k, so that the electrode body 40 is impregnated with the electrolyte 5. The liquid inlet 30k is then covered from the outside with the sealing member 12, and the sealing member 12 is laser welded hermetically to the case 10.

Next, in “initial charging and aging step S5”, a charging device (not shown) is connected to the battery 1 to perform initial charging on the battery 1. Then, the initially charged battery 1 is left to stand for a predetermined time so that the battery 1 is aged. In this manner, the battery 1 is completed.

In the method of manufacturing the metal-resin joints 100, 200 of this embodiment, the pulsed laser beam LC is caused to travel in the recess forming steps S11, S12 to form a plurality of rows of consecutive recess areas 59, 39 in each of which a plurality of bowl-shaped recesses 37, 57 is arranged in a row in the consecutively forming direction MAH, MBH, in the row arrangement direction NAH, NBH, thereby to form the recess arranged portions 53, 33 including the nano-roughened portions 55, 35. Thus, the nano-roughened portions 55, 35 can be easily formed. Then, in the resin forming step S13, the resin members 70 are formed with the resin material 75 filling gaps between the high nanocolumns 58H, 38H standing numerously on the nano-roughened portions 55, 35, so that the resin members 70 hermetically joined to the nano-roughened portions 55, 35 over the entire periphery can be easily formed.

Further in this embodiment, in the recess forming steps S11, S12, the consecutive recess areas 59, 39 are formed in the shape of multiple continuous bands, to form the recess arranged portions 53, 33 including the nano-roughened portions 55, 35. Thus, the continuous band-shaped nano-roughened portions 55, 35 can be easily formed in the resin joined portions 51,31.

While the disclosure has been described in the light of the embodiment, it is to be understood that the disclosure is not limited to the embodiment, but may be applied by making changes as needed, without departing from the principle of the disclosure.

### REFERENCE SIGNS LIST

1 Battery (Power storage device)
10 Case
30 Case lid member (Metal member)
30h Through hole
30he Opening edge (of through hole)
30m Metal surface (of case lid member)
30me Opening peripheral surface (of metal surface)
31 Resin joined portion (of metal surface of case lid member)
33 Recess arranged portion (of resin joined portion of case lid member)
35 Nano-roughened portion (of recess arranged portion of case lid member)
36 Non-nano-roughened portion (of recess arranged portion of case lid member)
37 Bowl-shaped recess (of case lid member)
38 Nanocolumn (of case lid member)
38H High nanocolumn (of case lid member)
38L Low nanocolumn (of case lid member)
38p Particle (derived from case lid member)
39 Consecutive recess area (of case lid member)
40 Electrode body
50 Terminal member (Metal member)
50m Metal surface (of terminal member)
50mc Outer peripheral surface (of metal surface)
51 Resin joined portion (of metal surface of terminal member)
53 Recess arranged portion (of resin joined portion of terminal member)
55 Nano-roughened portion (of recess arranged portion of terminal member)
56 Non-nano-roughened portion (of recess arranged portion of terminal member)
57 Bowl-shaped recess (of terminal member)
58 Nanocolumn (of terminal member)
58H High nanocolumn (of terminal member)
58L Low nanocolumn (of terminal member)
58p Particle (derived from terminal member)
59 Consecutive recess area (of terminal member)
70 Resin member
75 Resin material
100 First metal-resin joint (consisting of terminal member and resin member)
200 Second metal-resin joint (consisting of case lid member and resin member)
IAH, IBH Circumferential direction (of resin joined portion)
LAH, LBH Width direction (of nano-roughened portion)
LAH1, LBH1 One side (of width direction)
LAH2, LBH2 The other side (of width direction)

MAH, MBH Consecutively forming direction

NAH, NBH Row arrangement direction
ha Height (of nanocolumn)
Da Diameter (of particle)
Db Diameter (of bowl-shaped recess)
LC Pulsed laser beam
S1 Metal-resin joint manufacturing process
S11 First recess forming step
S12 Second recess forming step
S13 Resin forming step

What is claimed is:

1. A metal-resin joint comprising:
a metal member having a continuous band-shaped resin joined portion on a metal surface; and
a resin member joined to the resin joined portion over the entire periphery in a circumferential direction of the resin joined portion to be fixed to the metal member, wherein the resin joined portion of the metal member has a recess arranged portion in which numerous bowl-shaped recesses each having a diameter of 30 μm to 300 μm and dented in the form of a bowl are arranged while partially overlapping, the recess arranged portion having a continuous band shape extending over the entire periphery in the circumferential direction,
wherein the recess arranged portion includes a nano-roughened portion having a continuous band shape extending over the entire periphery in the circumferential direction, the nano-roughed portion having nanocolumns formed by joining particles derived from a metal that forms the metal member and having a diameter of 100 nm or less together like strings of beads, into the form of columns, the nanocolumns comprising high nanocolumns standing numerously on the nano-roughened portion and having a height of 40 nm or greater,
wherein the recess arranged portion includes a non-nano-roughened portion having no nanocolumn or low nanocolumns standing numerously on the non-nano-roughened portion and having a height that is smaller than 40 nm,
wherein the resin member is joined to the nano-roughened portion over the entire periphery with a resin material that forms the resin member filling gaps between the high nanocolumns standing numerously on the nano-roughened portion, and
wherein an interface of the metal member and the resin member between one side and the other side of the nano-roughed portion in a width direction is hermetically sealed.

2. The metal-resin joint according to claim 1, wherein:
the metal member is a bar-shaped member in which the metal surface has an outer peripheral surface, and the metal member has the recess arranged portion including the nano- roughened portion of the continuous band shape surrounding the outer peripheral surface; and
the resin member is a continuous member surrounding the outer peripheral surface of the metal member, and the resin member is joined to the nano-roughened portion of the continuous band shape over the entire periphery.

3. The metal-resin joint according to claim 1, wherein:
the metal member is configured to have a through hole, and the metal surface has an opening peripheral surface surrounding an opening edge of the through hole, the opening peripheral surface having the recess arranged portion including the nano-roughened portion of the continuous band shape surrounding the opening edge; and
the resin member is joined to the nano-roughened portion of the continuous band shape surrounding the opening edge over the entire periphery.

4. A method of manufacturing a metal-resin joint including
a metal member having a continuous band-shaped resin joined portion on a metal surface, and
a resin member joined to the resin joined portion over the entire periphery in a circumferential direction of the resin joined portion to be fixed to the metal member,
wherein the resin joined portion of the metal member has a recess arranged portion in which numerous bowl-shaped recesses each having a diameter of 30 μm to 300 μm and dented in the form of a bowl are arranged while partially overlapping, the recess arranged portion having a continuous band shape extending over the entire periphery in the circumferential direction,
wherein the recess arranged portion includes a nano-roughened portion having a continuous band shape extending over the entire periphery in the circumferential direction, the nano-roughed portion having nanocolumns formed by joining particles derived from a metal that forms the metal member and having a diameter of 100 nm or less together like strings of beads, into the form of columns, the nanocolumns comprising high nanocolumns standing numerously on the nano-roughened portion and having a height of 40 nm or greater,
wherein the recess arranged portion includes a non-nano-roughened portion having no nanocolumn or low nanocolumns standing numerously on the non-nano-roughened portion and having a height that is smaller than 40 nm,
wherein the resin member is joined to the nano-roughened portion over the entire periphery with a resin material that forms the resin member filling gaps between the high nanocolumns standing numerously on the nano-roughened portion, and
wherein an interface of the metal member and the resin member between one side and the other side of the nano-roughed portion in a width direction is hermetically sealed,
the method comprising:
recess forming of forming the numerous bowl-shaped recesses in the resin joined portion of the metal member by intermittently applying a pulsed laser beam to the resin joined portion while shifting an irradiation position, to form the recess arranged portion; and
resin forming of forming the resin member joined to the metal member after the recess forming,
wherein, in the recess forming, the pulsed laser beam is caused to travel in a consecutively forming direction that intersects a width direction of the resin joined portion, to form a consecutive recess area in which the bowl-shaped recesses are arranged in a row in the consecutively forming direction while partially overlapping,
wherein formation of the consecutive recess area is repeated a plurality of times in a row arrangement direction perpendicular to the consecutively forming direction, to arrange a plurality of rows of the consecutive recess areas in the row arrangement direction while partially overlaying the consecutive recess areas to form the recess arranged portion including the nano-roughened portion, and
wherein, in the resin forming, the resin member hermetically joined to the nano-roughened portion over the entire periphery and joined to the resin joined portion over the entire periphery is formed with the resin material filling gaps between the high nanocolumns standing numerously on the nano-roughened portion.
